(19) United States
(12) Patent Application Publication
(10) Pub. No.: US 2026/0127790 A1
(43) Pub. Date: May 7, 2026

(54) IMAGE PROCESSING APPARATUS, CONTROL METHOD, AND MEDIUM

(71) Applicant: CANON KABUSHIKI KAISHA, Tokyo (JP)

(72) Inventor: Kohei FURUYA, Tokyo (JP)

(21) Appl. No.: 19/375,314

(22) Filed: Oct. 31, 2025

(30) Foreign Application Priority Data
Nov. 6, 2024 (JP) 2024-194555

(51) Int. Cl. G06T 11/60; G06T 7/13

(52) U.S. Cl. CPC G06T 11/60; G06T 7/13; G06T 2207/20092

(57) ABSTRACT

An image processing apparatus is provided. The image processing apparatus determines a parameter of correction processing for extended image data generated by an image extension function, the extended image data in which image data is extended, based on feature information for each of regions including an original image region before extension and an extended region included in the extended image data generated by the image extension function, and corrects the extended image data using the parameter having been determined.

### BACKGROUND

### Field of the Technology

The technology of the present disclosure relates to an image processing apparatus, a control method, and a medium, and relates to image processing on an extended image in particular.

### Description of the Related Art

In recent years, image data can be extended with the development of the generative AI technology. This enables generation of a region not existing in the original image and creation of an image having a wider visual field, and enables generation of a subject not existing in the original image in a specific region of the image. A case of applying such a technology to an image requiring post-processing, such as a RAW image, will be considered. In such a case, the extended region may have different characteristics from the original region, and as a result, a region having different characteristics may be included in one extended image. In such an image, due to a difference in characteristics between the original region and the extended region, there is a possibility that a difference in color tone and luminance between these regions is visualized by post-processing, resulting in an unnatural image.

Known technologies regarding white balance, which is one of post-processing of an image, include technologies described in, for example, Patent Document 1 and Patent Document 2. Japanese Patent Laid-Open No. 2012-039256 discloses a configuration in which, when an image is cut out at a set aspect ratio at the time of image recording, an evaluation value for white balance control is calculated by changing a use ratio between the entire image to be cut out and a common region of an image to be used regardless of the aspect ratio. In Japanese Patent Laid-Open No. 2012-039256, when a main subject is included in a non-common region that is used or not used depending on the setting of the aspect ratio, a use ratio of the common region is increased to calculate a color level for white balance control.

In Japanese Patent Laid-Open No. 2004-064676 discloses a configuration in which, when a specific region is cut out and stored as an electronic zoom region at the time of image recording, color extraction for white balance is performed also from the outside of the region to be cut out. In Japanese Patent Laid-Open No. 2004-064676, when a light source different from a light source irradiating a subject is present outside the electronic zoom region, white balance control is performed by lowering a weight of a color extracted from the outside.

Japanese Patent Laid-Open No. 2012-039256 suppresses a change in luminance and color balance of a main subject such as a face of a person due to a change in setting of an aspect ratio, and controls a difference in white balance between images having different aspect ratios having been set. Japanese Patent Laid-Open No. 2004-064676 assumes that a specific angle of view is cut out and stored, and an object thereof is to make the color balance and the luminance of an image to be cut out appropriate by effectively utilizing information of an outer region to be cut out. Therefore, for example, when the light source different from the light source irradiating the subject is present outside the electronic zoom region, the weight of the color extracted from the outside is lowered, but the weight is not changed if the light source is present inside the electronic zoom region.

Even if such a known technology is applied to image data extended by AI generation or the like, the action described in each patent document is only applied to the extended image data. Therefore, it is difficult to improve image quality such as unnaturalness of an image after post-processing due to a difference in characteristics between the original region and the extended region.

### SUMMARY

The technology of the present disclosure makes it possible to perform image processing also in consideration of an extended region while reducing an influence of the extended region on an original region in an extended image.

According to one aspect of the present disclosure, provided is an image processing apparatus comprising: at least one memory storing instructions; and at least one processor that is in communication with the at least one memory and that, when executing the instructions, cooperates with the at least one memory to execute processing, the processing including determining a parameter of correction processing for extended image data generated by an image extension function, the extended image data in which image data is extended, based on feature information for each of regions including an original image region before extension and an extended region included in the extended image data generated by the image extension function, and correcting the extended image data using the parameter having been determined.

According to the above configuration, it is possible to perform image processing also in consideration of an extended region while reducing an influence of the extended region on an original region in an extended image.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of an image capturing apparatus 100 according to an embodiment and a modification.

FIGS. 2A and 2B are flowcharts showing extended image storage processing and extended image development processing to be executed in the image capturing apparatus 100 according to the embodiment and the modification of the embodiment.

FIG. 3 is a view for describing the extended image storage processing to be executed in the image capturing apparatus 100 according to the embodiment and the modification of the embodiment.

FIG. 4 is a view for describing development parameter calculation processing to be executed in the image capturing apparatus 100 according to Modification 1 of the embodiment.

FIG. 5 is a view for describing histogram calculation processing to be executed in the image capturing apparatus 100 according to Modification 2 of the embodiment.

FIG. 6 is a view for describing an extended region acquisition processing to be executed in the image capturing apparatus 100 according to Modification 3 of the embodiment.

FIG. 7 is a view for describing an example of a user operation according to a second embodiment.

FIG. 8 is a flowchart showing extended image development processing to be executed in the image capturing apparatus 100 according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

An embodiment described below is an example of an image capturing apparatus having a function of performing image processing also in consideration of an extended region while reducing an influence of the extended region on an original region in an extended image, as an example of an image processing apparatus. However, the technique of the present disclosure can be applied to any equipment that can generate an image having been subjected to image processing also in consideration of an extended region while reducing an influence of the extended region on an original region in an extended image.

### Hardware Configuration of Image Capturing Apparatus

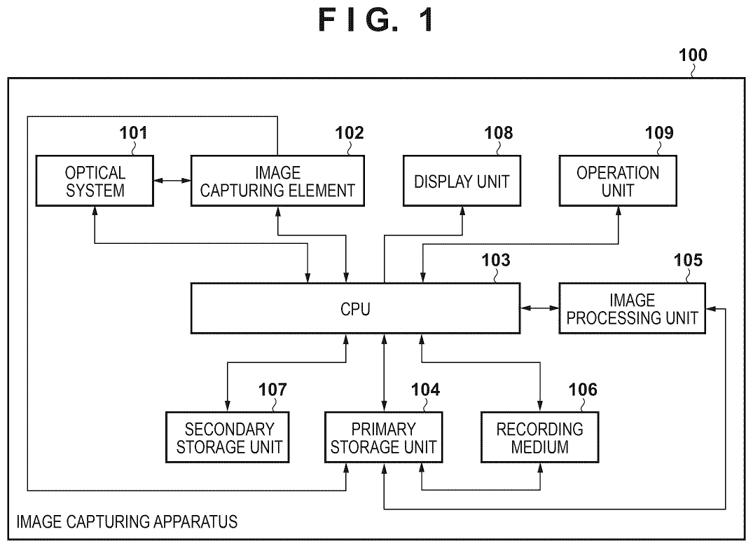

Hereinafter, the hardware configuration of the image capturing apparatus 100 according to the present embodiment will be illustrated with reference to the block diagram of FIG. 1. The image capturing apparatus 100 can include, for example, an apparatus provided for use in image capturing such as a digital camera and a digital video camera, or electronic equipment having an image capturing function such as a camera-equipped mobile phone and a camera-equipped computer.

An optical system 101 is an image forming optical system including a lens group, a shutter, and an aperture. The lens group can include a correction lens that corrects camera shake and the like and a focus lens. The optical system 101 forms an image of subject light onto an image capturing surface of an image capturing element 102 based on a control signal received from a CPU 103 described later. The image capturing element 102 is, for example, an imaging sensor such as a charge coupled device (CCD) image sensor or a complementary metal oxide semiconductor (CMOS) image sensor. The image capturing element 102 photoelectrically converts, into an image signal, an optical image formed on an image capturing surface by the optical system 101. The image signal is digitized into digital image data (called image data) and stored or subjected to image processing.

The CPU 103 is a control apparatus that controls the operation of each block included in the image capturing apparatus 100. The CPU 103 controls the operation of each block by reading out an operation program of each block stored in a secondary storage unit 107 and deploying it into a primary storage unit 104 to execute. In operation control of each block, the CPU 103 appropriately transmits a control signal corresponding to the corresponding operation to each block. The CPU 103 may be called a processor.

The secondary storage unit 107 is a nonvolatile storage apparatus such as an electrically erasable programmable read-only memory (EEPROM), for example. The secondary storage unit 107 stores various types of setting information necessary for the operation of each block in addition to the operation program of each block included in the image capturing apparatus 100, firmware of the image capturing apparatus 100, and the like. The primary storage unit 104 is, for example, a volatile storage apparatus such as a random access memory (RAM), for example. The primary storage unit 104 is used not only as a deployment region of the operation program of each block but also as a work memory that stores temporary data output by the operation of each block. The information stored in the primary storage unit 104 can be used by an image processing unit 105 or recorded in a recording medium 106.

The recording medium 106 is a recording apparatus configured detachably from the image capturing apparatus 100, such as a semiconductor memory card. When shooting is performed in the image capturing apparatus 100, the recording medium 106 is used to record image data stored in the primary storage unit 104 by the shooting. The data recorded in the recording medium 106 can be used in external equipment such as a personal computer (PC) by attaching the recording medium 106 to the external equipment.

A display unit 108 is a display apparatus such as an LCD, for example. The display unit 108 is used for displaying a viewfinder image at the time of shooting, displaying a shot image, displaying a graphical user interface (GUI) image for interactive operation, and the like. At the time of shooting by the image capturing apparatus 100, live view display can be performed on the display unit 108. It is also possible to display, on the display unit 108, image data selected from among shot image data (image files) stored in the recording medium 106.

An operation unit 109 is a user interface such as, for example, a button, a lever, or a touch panel. When an operation input is made to various operation members, the operation unit 109 transmits a control signal corresponding to the operation input to the CPU 103. In addition to this, the operation unit 109 can include input equipment using a voice, a line of sight, or the like. The operation unit 109 further includes a touch panel integrated with the display unit 108. The user can perform an operation with the touch panel on the display of the display unit 108.

The image processing unit 105 is an apparatus that executes various types of image processing on an image. In the present embodiment, the image processing unit 105 is configured to be able to apply a plurality of types of image processing to an image. Which image processing to be executed by the image processing unit 105 may be determined as a pattern for each shooting mode, for example. In the aspect, the pattern of the image processing to be applied to a captured image by the image processing unit 105 is controlled based on the information of the shooting mode set by the user. The image processing to be performed on a captured image includes processing such as color tone adjustment as well as what is called development processing. In the present embodiment, the image processing unit 105 executes AI extension processing on image data. The image processing unit 105 may include a graphic processing unit (GPU) as a processor that executes processing.

Note that, in the example of FIG. 1, description will be given on the assumption that the image capturing apparatus 100 includes the image processing unit 105 as one piece of hardware and the image processing unit 105 executes image processing, but implementation of the present disclosure is not limited to this. Part of image processing may be implemented by the CPU 103 executing a corresponding processing program. Alternatively, the image processing may be executed by an information processing apparatus such as a server connected via a communication unit not illustrated. In that case, the image data may be transmitted to the information processing apparatus via the communication unit, and the processed image data subjected to the image processing there may be transmitted to the image capturing apparatus 100.

### Overview of Development Parameter Calculation Processing

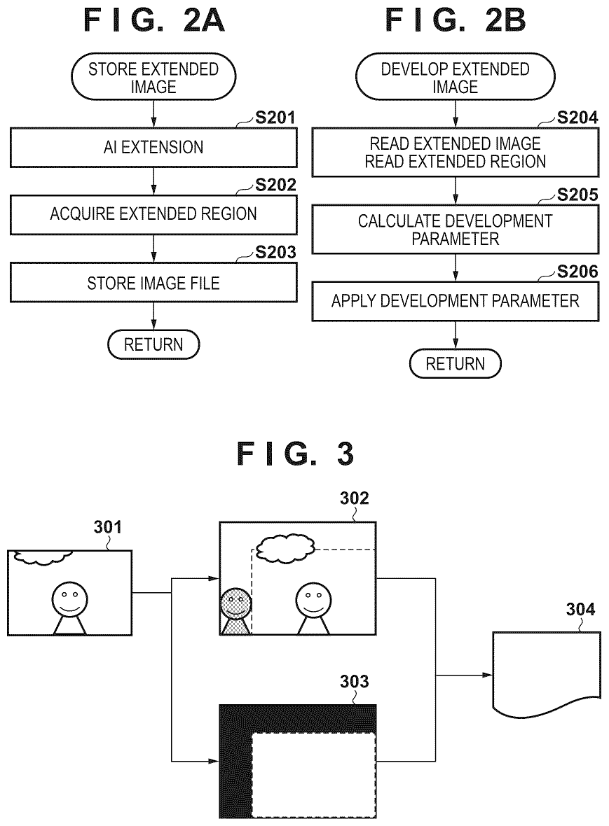

Specific processing of the extended image development processing performed by the image capturing apparatus 100 of the present embodiment will be described below with reference to the flowcharts of FIGS. 2A and 2B. The processing corresponding to the flowcharts is described by being divided into extended image storage processing (FIG. 2A, S201 to S203) for storing an AI-extended image and extended image development processing (FIG. 2B, S204 to S205) for developing the stored image. The extended image storage processing of the former can be implemented by, for example, the CPU 103 reading out a corresponding processing program stored in the secondary storage unit 107, deploying it into the primary storage unit 104 to execute. The present extended image storage processing will be described as being started, for example, when an operation input related to the AI extension processing is performed. The extended image development processing of the latter can also be executed in an external application or the like not illustrated, for example, in addition to being executed by the CPU 103, similarly to the extended image storage processing. Both processings are implemented by the CPU 103 executing a program loaded in a memory, but the present embodiment includes processing in which the CPU 103 controls to cause the image processing unit 105 to perform.

In the extended image storage processing of the present embodiment, since the image processing unit 105 performs AI extension of shot image data, a learned model learned by machine learning stored in the secondary storage unit 107, for example, is loaded into the primary storage unit 104 to be used. This learned model outputs image data extended with the shot image data (RAW image data in the present example) and a parameter for extension as inputs. The parameter for extension may include a theme of an image added by extension, for example, and a position (e.g., a position inside the image or a position outside the image) at which an extended region is superimposed or added. Alternatively, a subject or the like in the original image to be deleted from the original image may be included. The learned model may be a model learned by an information processing apparatus other than the image capturing apparatus 100. The learning may be performed using a known method, and the learning may be performed with, for example, the original image data and a parameter for extension as input data, and the extended image data to be output or the feature data thereof as correct answer data. Of course, the manager may view the image to be output and give feedback of evaluation to a machine learning program. Note that learning may be performed by the image capturing apparatus 100, but in that case, learning processing may be performed by the image processing unit 105.

The processing of FIG. 2A may be executed in response to the user selecting image data and inputting an instruction including a parameter for image extension in the operation unit 109 of the image capturing apparatus 100.

In S201, the image processing unit 105 performs AI extension under the control of the CPU 103. The extension processing can be performed using extension by various types of generative AI. The AI extension is executed with the target image data and the parameter for extension (extension parameter) as inputs, and the extended image data is output. The target image data mentioned here may be image data selected from shot image data stored in the recording medium 106. The extension parameter may be a gesture or a character string input by the user from the operation unit 109 or the like. An example of gesture will be described with reference to FIG. 7 also in the second embodiment, and may include an operation such as reduction by pinch-in or region setting by designation of a frame. Alternatively, it may be a parameter selected by the user from set parameters. The extension parameters may be collected into a set of parameter group as an extension profile, for example, and in that case, the user may select a desired extension profile to instruct extension. Note that the present embodiment assumes that both the target image data and the extended image data are RAW data.

In S201, for example, the CPU 103 loads the target image data selected by the user from the recording medium 106 into the primary storage unit 104, and gives an instruction of extension parameter AI extension to the image processing unit 105. The image processing unit 105 may execute the AI extension processing in response to the instruction. The extended image generated by the image processing unit 105 is stored in the primary storage unit 104.

In the extension, for example, in the vertical and horizontal directions of the image, it is possible to generate a region not existing in the original image and create an image having a wider visual field and generate a subject not existing in the original image in a specific region of the image. How to extend the target image data is designated by a parameter for extension. However, a specific extension manner corresponding to the parameter depends on the learned model. This can obtain an extended image 302 in which the visual field is extended in the upward direction and the leftward direction from a shot image 301 of FIG. 3, for example.

In S202, the image processing unit 105 acquires an extended region under the control of the CPU 103. The acquisition of the extended region may acquisition of information specifying the extended region (called extended region specifying information). Note that the extended region specifying information is also called region specifying information because the extended region is distinguished from the original image region before extension. Here, as in mask data 303 of FIG. 3, for example, it is possible to generate mask data corresponding to an extended region where the original region is 1 and the extended region is 0. That is, here, mask data corresponding to the extended region is generated as information specifying the extended region. For example, a correlation between the image data of the target image 301 and the image data of the extended image 302 may be obtained to determine a region corresponding to the target image in the extended image, and mask data in which the corresponding region is 1 and the non-corresponding region is 0 may be generated as extended region specifying information. Alternatively, the extended region specifying information may be held as coordinate information indicating the extended region. For example, the extended region may be specified by position information such as coordinates of the boundary (or contour) between the original image region and the extended region, and the position information or a vector connecting the position information may be used as extended region specifying information. The extended region specifying information such as the mask data having been generated is stored in the primary storage unit 104. Similarly to S201, in S202, the CPU 103 may give an instruction for generating extended region specifying information to the image processing unit 105, and in response to that, the image processing unit 105 may generate and store, into the primary storage unit 104, extended region specifying information.

In S203, the CPU 103 stores an image file. Here, the extended image 302 and the extended region specifying information such as the mask data 303 acquired in S202 are stored together (i.e., associated with each other) as an image file 304.

Note that in the extended image storage processing, the CPU 103 may execute the entire process without using the image processing unit 105.

From S204 illustrated in FIG. 2B onward, the extended image development processing is performed. The present extended image development processing will be described as being started, for example, when a development processing operation input of an AI-extended image is performed. In the extended image development processing, RAW data stored as extended image data is subjected to development processing. In the development processing of RAW data, post-processing such as white balance, luminance adjustment, hue adjustment, and noise removal is performed to generate image data after development (developed image data), and the developed image data is stored in a format different from the RAW data, for example, as JPEG data. Note that in the present embodiment, determination of those parameters of the post-processing is also executed. In the present embodiment, the extended image development processing will also be described as being implemented by the image capturing apparatus 100, particularly the CPU 103 thereof, executing a program loaded into a memory such as the primary storage unit 104. Note that the program includes processing that the CPU 103 controls to cause the image processing unit 105 to execute. The processing of FIG. 2B may be started when the user selects image data of a development target in the image capturing apparatus 100 and designates development thereof.

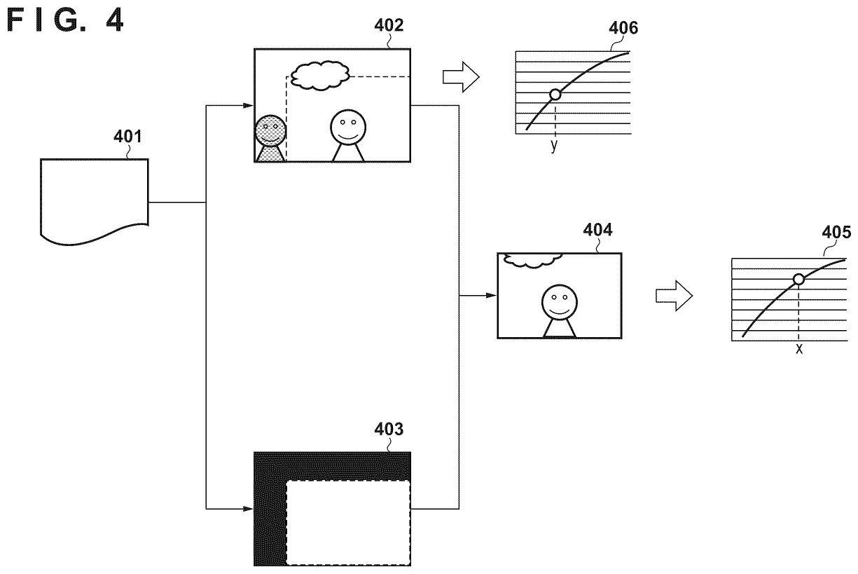

In S204, the CPU 103 reads out the extended image and information regarding the extended region. Here, as in FIG. 4, extended image data 402 and extended region specifying information 403 stored together with the extension image are read out from an image file 401 selected from the image files stored in the recording medium 106, and the extended image data 402 and the extended region specifying information 403 loaded into the primary storage unit 104.

In S205, the image processing unit 105 performs development parameter calculation under the control of the CPU 103. The development parameter may be a parameter for correction processing on the image data. Here, for example, a region 404 corresponding to the region in which the value of the mask data is 1 is extracted from the extended image data 402 according to the mask data that is the extended region specifying information 403. That is, the region corresponding to the original image is extracted from the extended image data. Then, the feature amount is extracted only from the region, that is, from the original image region excluding the extended region, and the development parameter is calculated from the feature amount. The development parameter is a parameter of the post-processing executed in S206, and is obtained for each type of post-processing. The calculation of the development parameter may be performed by, for example, a predetermined procedure, or a procedure performed by a known digital camera may be used. However, the target region is not the entire shot image but is limited to the original image region specified by the extended region specifying information such as mask data.

For example, when white balance adjustment is performed as one of post-processing, a color distribution on the image is acquired as a feature amount with a region that is a target for determining a parameter, for example, here, an original image region corresponding to mask data as a target. Then, the color temperature of light source light is estimated from the feature amount, and a coefficient of each color channel for correcting it is determined as a parameter. When exposure correction is performed, a histogram of luminance, which is a feature amount, is created with the original image region corresponding to mask data as a target, and a parameter for correcting luminance is determined based on the histogram. Of course, these are examples, and parameters for other post-processing may be determined, or may be determined by other methods.

In S206, the image processing unit 105 performs the post-processing by applying the development parameter under the control of the CPU 103. Here, the development parameter calculated in S205 is applied to the entire extended image data 402, and the post-processing is performed to generate a final image. The generated image data may be stored as it is, or may be compressed and stored as a JPEG file or the like.

Note that in the extended image development processing, the CPU 103 may execute the entire process of FIG. 2B without using the image processing unit 105.

As described above, according to the image processing apparatus of the present embodiment, it is possible to reduce the influence of the extended region on the original region. For example, when post-processing is performed targeting the entire image region including the region (extended region) extended by the extension processing, excessive adjustment may occur in the region (original image region) corresponding to the original image, but the present embodiment can prevent excessive adjustment with respect to the original image region. Conversely, when post-processing is performed targeting the entire image region including the extended region, adjustment may become insufficient in the original image region, but the present embodiment can prevent insufficient adjustment with respect to the original image region. This, also in post-processing on the extended image, the post-processing suitable for the original image region can be performed, and the quality of the developed image can be improved.

### Modification 1

In the above-described embodiment, an aspect in which the development parameter is calculated only from the region represented by the mask data has been described. However, implementation of the present disclosure is not limited to this. For example, it is also possible to calculate the development parameter from the color temperature of the white balance calculated from the original image region 404 represented by the mask data (e.g., color temperature x of a color temperature curve 405 in FIG. 4) and the color temperature of the white balance calculated from the entire extended image data (color temperature y of a color temperature curve 406). The calculation can be performed by, for example, the following expression.

$$Color temperature = x \times 0.8 + y \times 0.2$$

That is, while the weight (or contribution ratio) of the color temperature of the original image region is set to 1 in the above embodiment, a value combined by setting the weight of the color temperature of the original image region to 0.8 and the weight of the color temperature of the entire extended image to 0.2 is determined as color temperature in the present modification. That is, the feature information of the entire extended image data is determined by combining the feature information generated from each region of the extended image data with a weight for each region.

By applying the development parameter calculated in consideration of the characteristics of the original image region to the characteristics of the entire extended image in this manner, it is possible to obtain a development result also in consideration of the extended region itself to be finally stored while reducing the influence of the extended region on the original region.

### Modification 2

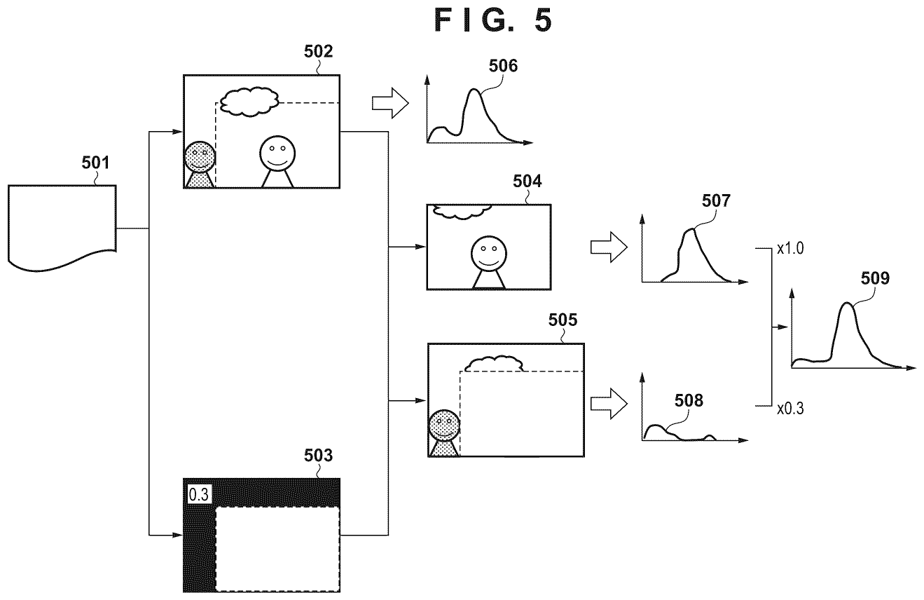

In the above-described embodiment, an aspect in which the development parameters calculated from each of the original image region and the entire region including the extended region are combined and applied has been described. However, implementation of the present disclosure is not limited to this. For example, as in FIG. 5, an original image region 504 and an extended region 505 are acquired based on extended image data 502 and mask data 503 having been read out from an image file 501. In the extended image data 502, a dark face due to insufficient exposure is generated in the extended region. Therefore, when the histogram indicating the distribution of the luminance in the extended image data 502 is acquired as it is, a histogram distributed also in a dark part (left side of the graph) as in a histogram 506 is obtained. When dark part correction is normally performed as it is, strong dark part correction may be applied to the entire extended image in order to brighten the dark part, and excessive correction may be performed including the original image region. Therefore, when a histogram 507 acquired from the original image region 504 is h1(L) and a histogram 508 acquired from the extended region 505 is h2(L), a histogram 509 can be calculated as follows. Note that the histogram 509 is represented by a name h3(L).

$$h 3 ( L ) = h 1 ( L ) \times 1. + h 2 ( L ) \times 0.3$$

A correction amount of the dark part correction is calculated based on the histogram calculated in this manner. That is, also in the present modification, the feature information of the entire extended image data is determined by combining the feature information generated from each region of the extended image data with a weight for each region. Doing this can obtain a development result also in consideration of the extended region itself to be finally stored while reducing the influence of the extended region on the original image region. In other words, by performing post-processing with the development parameters calculated in consideration of the characteristics of the extended region to the characteristics of the image of the original image region, it is possible to obtain a development result also in consideration of the extended region while reducing the influence of the extended region on the original image region.

### Modification 3

In the above-described embodiment, processing of handling separately the original image region and the extended region using mask data and coordinate information indicating the extended region has been described. However, implementation of the present disclosure is not limited to this. For example, the mask data can have a plurality of mask values.

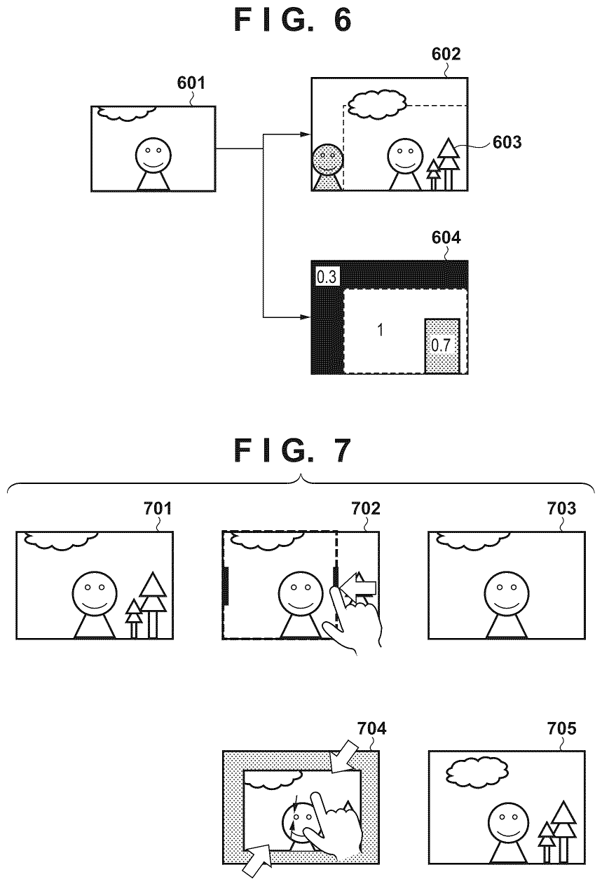

In the generative AI, in addition to the processing of extending the angle of view of the image data as described earlier in the first embodiment, it is also possible to add a subject to a specific region in an image. The subject can be erased by combining a background image. For example, it is possible not only to extend the angle of view as in an extended image 602 from a shot image 601 in FIG. 6 but also to add a tree to a region 603. In such a case, as described above, the generated region does not necessarily have the same characteristics as the original region, but a development parameter in consideration of also this region to some extent may be desirable because the subject is added intentionally by the user. Note that generation of an image in which an object such as another subject is added into the original image, or together with deletion of the subject, is called extension of the image, and even when the angle of view of the original image is not changed, the region including the added object is called an extended region. Therefore, extension of the image can be called alteration or combining of an image, and the extended region can be called an altered region or a combined region.

Therefore, in the above-described case, depending on the manner of extension for each region, mask data in which the coefficient of an original image region 604, which is not extended, is 1, the coefficient of an automatically generated extended region is 0.3, and the coefficient of the region generated by the user designating the subject is 0.7 is generated. In this case, for example, at the time of histogram calculation, a histogram h(L) can be calculated as follows based on a mask value m(x, y) and luminance L(x, y) at coordinates (x, y).

$$h ( L ) = {\sum }_{x , y} \{ m ( x , y ) \times δ ( L - L ( x , y ) \}$$

Here, δ is the Dirac delta function, and returns 1 when the argument is zero and 0 otherwise. The histogram h(L) indicates the number of pixels of the luminance L weighted by the mask value m(x, y) for the entire extended image. Here, the weighting is implemented by multiplying the position of the pixel of the luminance L by the corresponding mask value. That is, also in the present modification, the feature information of the entire extended image data is determined by combining the feature information generated from each region of the extended image data with a weight for each region. However, in the present modification, the weight is not a fixed value but is given as mask data. What weight to be given to which region indicated by the mask data may be determined in advance as in the above example.

Note that it is also possible to hold the weight not as a mask value as described above but as label information or as a coefficient corresponding to coordinate information indicating each region. In such a case, it is also possible to set a weight (or coefficient) depending on the label or the region again at the time of development parameter calculation. More flexible weighting can be performed by configuring the setting to be able to be designated by the user.

In this manner, by performing post-processing with the development parameters calculated in consideration of the characteristics of the extended region to the characteristics of the image of the original image region, it is possible to obtain a development result also in consideration of the extended region while reducing the influence of the extended region on the original image region. Furthermore, in the present modification, the weight for each region can be set by setting a coefficient as a mask value.

### Second Embodiment

In the embodiment and the modifications described above, an aspect in which an extended image in which AI extension or the like is applied to a shot image is once stored in an image file has been described. In the present embodiment, another aspect in which extension processing is simultaneously performed at the time of shooting will be described.

An example of a scene in which the extension processing is simultaneously performed at the time of shooting will be described with reference to FIG. 7. FIG. 7 illustrates an example of a screen on which an image is displayed on the display unit 108 including a touch panel and an operation thereof. A screen 701 illustrates an example of live view display at the time of shooting standby. On this screen, for example, in a case of finding the tree on the right side of the image obstructive and desiring to erase it, the user slides a guide at the screen edge as in a screen 702 and limit the shooting region, thereby enabling generation of an image 703 in which the tree is erased by combining the extended image on the outer side of the region. In a case of desiring to perform shooting at a wider angle than the current live view display, the user can generate an image 705 by pinching in the screen as illustrated in a screen 704, reducing the shooting region, and extending an insufficient region. The screen operation is acquired by the CPU 103 as trajectory data or the like of the operation on the screen, and an extension parameter corresponding to the operation, such as erasure of the subject in a designated region or extension of a region that becomes empty due to reduction, is generated and stored in the primary storage unit 104, for example. In this manner, in the present embodiment, the extension parameter for extending target image data is set before shooting of the target image data.

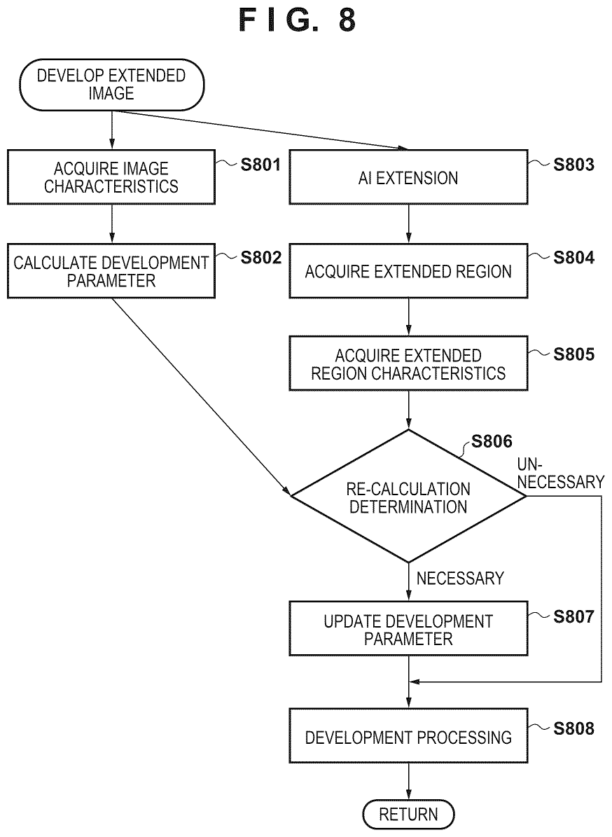

Specific processing of the extended image development processing performed by the image capturing apparatus 100 of the present embodiment will be described below with reference to the flowchart of FIG. 8. The processing corresponding to the flowchart can be implemented by the CPU 103 reading out a corresponding processing program stored in the secondary storage unit 107, for example, deploying it into the primary storage unit 104 to execute. The extended image development processing of FIG. 8 will be described as being started immediately after shooting in response to a shooting instruction with a shutter button or the like, for example, when the user performs an operation input (e.g., the operation illustrated on the screen 702 or the screen 704 of FIG. 7) to perform extension processing shooting. At the time of start, the extension parameter input by the screen operation before shooting is stored in, for example, the primary storage unit 104, and image data shot in response to a subsequent shooting operation is also stored in the primary storage unit 104. The image data stored in the primary storage unit 104 is target image data of the extension processing, and the target image data is also called a shot image in the following description. Note that execution of S801 and S803 may be started in parallel or asynchronously. However, with the end time point of S802 and the end time point of S805 as synchronization points, S806 and subsequent steps are executed after waiting for completion of any delayed processing.

In S801, the image processing unit 105 acquires image characteristics for the shot image under the control of the CPU 103. In the present processing, similarly to the time of normal shooting in which generation extension is not performed, it is possible to always acquire the characteristic information for development parameter calculation from image data (i.e., unprocessed RAW data having been shot) corresponding to the screen 701 of FIG. 7 regardless of generation extension designation of the user. The characteristic information to be acquired includes white balance and a histogram indicating luminance distribution as illustrated in the first embodiment, for example.

In S802, the image processing unit 105 determines the development parameter by calculating the development parameter under the control of the CPU 103. Also in the present processing, similarly to S801, the calculation of the development parameter can be performed in the same manner as in normal shooting. The calculation may be performed in the same manner as the calculation of the development parameter targeting the original image region corresponding to the mask data in S205, for example.

In S803, the image processing unit 105 performs AI extension processing under the control of the CPU 103. This can obtain an extended image such as the image 703 or the image 705. Here, the AI extension processing may be executed in the same manner as in S201 of FIG. 2A, but the target image data is a shot image, and the extension parameter stored in the primary storage unit 104 may be used as an extension parameter.

In S804, the image processing unit 105 acquires the extended region under the control of the CPU 103. Here, it is possible to generate mask data for distinguishing the extended region as described above and to acquire coordinate information indicating the extended region. This processing may be the same as that in S202.

In S805, the image processing unit 105 acquires characteristics of the extended region (extended region characteristics) under the control of the CPU 103. The extended region characteristics may be characteristics targeting only the region extended by the extension processing, or may be characteristics targeting the entire extended image data including the original image region and the extended region. As described in Modifications 1 to 3 of the first embodiment, this may be determined depending on the weight (i.e., coefficient to be multiplied) given to the characteristic information of the extended region. As described with reference to FIG. 4 for example, if the characteristic information targeting the entire extended image data is weighted, the characteristic information targeting the entire extended image data may be acquired. Alternatively, as described with reference to FIGS. 5 and 6, if the original image region and the extended region are each weighted, the characteristic information targeting only the extended region may be acquired.

Next, in S806, the image processing unit 105 performs recalculation determination under the control of the CPU 103. At this time, synchronization is performed with the end of S802 that has been executed in parallel. That is, if S802 has ended, S806 is executed, and if not, S806 is executed after waiting for the end.

In the recalculation determination, for example, the histogram distributions of the original image region and the extended region are compared, and if the similarity is high, it can be determined that the recalculation is unnecessary. The similarity can be determined based on various criteria, for example, it is determined to be similar when an average value, variance, distribution of peak, or the like is within a predetermined difference. Alternatively, in a case where no subject exists in the extended region or the extended region is originally narrow, it may be determined that recalculation is unnecessary.

If it is determined in S806 that recalculation determination is necessary, the image processing unit 105 updates in S807 the development parameter under the control of the CPU 103. In the present processing, processing similar to that in S205 of FIG. 2B may be performed. On the other hand, if it is determined that recalculation is unnecessary in S806, the processing proceeds to S808. This is because the development parameter of the original image region has already been calculated in S802 at the start point of S806, and thus post-processing may be performed using the development parameter. By this, the processing time can be shortened by skipping the recalculation processing of the development parameter.

In S808, the image processing unit 105 performs post-processing by applying the development parameter under the control of the CPU 103. Here, the calculated development parameter is applied to the entire extended images 703 and 705, and final image data is generated. The generated image data corresponds to the developed image and is stored in the recording medium 106. When stored, the image data may be stored as compressed image data such as JPEG.

According to the present embodiment, AI extension processing, acquisition of the characteristic information of the original image region, and determination of the development parameter can be performed in parallel by the above-described configuration and processing procedure. By that, when it is not necessary to determine again the development parameter corresponding to the extended region, the processing time can be shortened, and post-processing (i.e., correction processing or RAW development processing) can be quickly performed. If post-processing corresponding to the extended region is necessary, execution of it can improve the quality after development of the AI-extended image.

### Other Modifications

Note that it is also possible to always update the development parameter based on the extended image in the procedure of FIG. 8. In this case, S801, S802, and S806 are unnecessary, and S803 to S805, S807, and S808 may be executed.

Note that, in all the above-described embodiments and modifications thereof, the image extension function using AI has been described, but the technique of the present disclosure can also be applied to an image extended by an image extension function not using AI. For example, all the embodiments and the modifications thereof can be applied to extended image data created by combining a shot image with a background prepared in advance, extended image data created by combining a plurality of image data by cutting, and the like. All the above-described embodiments and modifications thereof can also be applied to extension data created by filling a color of a designated portion with respect to a range designated by a manual operation.

In the embodiments and the modifications described above, a parameter is generated by weighting the feature information of each region using the feature information (also called a feature amount) of the region specified by the region specifying information. On the other hand, when the original image data before extension and the extended image data after extension shot as in the second embodiment are held, the original image region and the extended region can be specified from those image data, and therefore the region specifying information does not need to be generated. If each region is specified without generating the region specifying information, the parameters can be determined and the development processing can be performed as in all the above-described embodiments and modifications. This eliminates the need for the processing of generating the region specifying information, eliminates the need for storing the generated region specifying information, and can reduce the processing load and reduce the necessary amount of resources for storage.

In the embodiments and the modifications described above, an example in which image extension and development processing of extended image data are performed by an image capturing apparatus such as a digital camera has been described. On the other hand, image data shot by an image capturing apparatus such as a digital camera may be stored in an information processing apparatus such as a personal computer, and the image data may be extended and developed by the information processing apparatus. In that case, a generative AI-based service provided via the Internet may be used as extension processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-194555, filed Nov. 6, 2024 which is hereby incorporated by reference herein in its entirety.

What is claimed is:

1. An image processing apparatus comprising:
at least one memory storing instructions; and
at least one processor that is in communication with the at least one memory and that, when executing the instructions, cooperates with the at least one memory to execute processing, the processing including
determining a parameter of correction processing for extended image data generated by an image extension function, the extended image data in which image data is extended, based on feature information for each of regions including an original image region before extension and an extended region included in the extended image data generated by the image extension function, and
correcting the extended image data using the parameter having been determined.

2. The image processing apparatus according to claim 1, wherein the processing further includes
generating region specifying information specifying an original image region before extension and an extended region included in the extended image data generated by the image extension function, and
the determining includes determining a parameter of correction processing for the extended image data based on feature information of the original image region and the extended region specified by the region specifying information.

3. The image processing apparatus according to claim 2, wherein the processing further includes
storing the extended image data and the region specifying information.

4. The image processing apparatus according to claim 2, wherein
the region specifying information is mask data corresponding to each of the original image region and the extended region.

5. The image processing apparatus according to claim 2, wherein
the region specifying information is position information of a boundary between the original image region and the extended region.

6. The image processing apparatus according to claim 1, wherein
the determining includes determining the parameter based on a feature amount generated from the original image region not including the extended region.

7. The image processing apparatus according to claim 1, wherein
the determining includes determining the parameter based on feature information in which feature information generated from the extended region and the original image region and feature information generated from the original image region not including the extended region are combined.

8. The image processing apparatus according to claim 2, wherein
the determining includes combining the feature information generated from each region specified by the region specifying information by applying a weight for each region.

9. The image processing apparatus according to claim 8, wherein
the weight for each region is determined depending on a manner of extension for each region by the image extension function.

10. The image processing apparatus according to claim 9, wherein
the manner of extension for each region includes automatic extension without designation of a subject by a user, extension with designation of a subject by a user, and non-extension.

11. The image processing apparatus according to claim 1, wherein the processing includes
providing the image extension function.

12. The image processing apparatus according to claim 11 further comprising

13. A non-transitory computer-readable storage medium storing a program that, when loaded and executed on a computer, causes the computer to perform processing, wherein the processing includes
determining a parameter of correction processing for extended image data generated by an image extension function, the extended image data in which image data is extended, based on feature information for each of regions including an original image region before extension and an extended region included in the extended image data generated by the image extension function, and
correcting the extended image data using the parameter having been determined.

14. A control method of an image processing apparatus, the control method comprising:
determining a parameter of correction processing for extended image data generated by an image extension function, the extended image data in which image data is extended, based on feature information for each of regions including an original image region before extension and an extended region included in the extended image data generated by the image extension function, and
correcting the extended image data using the parameter having been determined.
